(19) United States
(12) Patent Application Publication
(10) Pub. No.: US 2006/0074675 A1
(43) Pub. Date: Apr. 6, 2006

(54) Method of synthesizing creaky voice

(75) Inventor: Ercan Ferit Gigi, Eindhoven (NL)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(73) Assignee: Koninklijke Philips Electronics N.V., Eindhoven (NL)

(21) Appl. No.: 10/528,130

(22) PCT Filed: Aug. 8, 2002
(86) PCT No.: PCT/IB03/03554

§ 371 Date: Mar. 15, 2005

(30) Foreign Application Priority Data
Sep. 17, 2002 (EP) 02078850.1

(51) Int. Cl. G10L 13/04

(52) U.S. Cl. 704/261

(57) ABSTRACT

The invention relates to a method of synthesizing a signal comprising the steps of: a) providing of a first signal having first periods of a first type and second periods of a second type in an alternating sequence, b) selecting of one of the pitch bells for a first one of the required pitch bell locations by identifying the nearest neighboring period of the first one of the required pitch bell locations being of the first type, and selecting of the pitch bell of the identified period, c) selecting of one of the pitch bells for a second one of the required pitch bell locations by identifying a nearest neighboring period of the second one of the required pitch bell locations having the second type, and selecting the pitch bell of the identified period, whereby the steps b) and c) are carried out for all of the required pitch bell locations.

The present invention relates to the field of synthesizing of speech, and more particularly without limitation, to the field of text-to-speech synthesis.

The function of a text-to-speech (TTS) synthesis system is to synthesize speech from a generic text in a given language. Nowadays, TTS systems have been put into practical operation for many applications, such as access to databases through the telephone network or aid to handicapped people. One method to synthesize speech is by concatenating elements of a recorded set of subunits of speech such as demisyllables or polyphones. The majority of successful commercial systems employ the concatenation of polyphones.

The polyphones comprise groups of two (diphones), three (triphones) or more phones and may be determined from nonsense words, by segmenting the desired grouping of phones at stable spectral regions. In a concatenation based synthesis, the conversation of the transition between two adjacent phones is crucial to assure the quality of the synthesized speech. With the choice of polyphones as the basic subunits, the transition between two adjacent phones is preserved in the recorded subunits, and the concatenation is carried out between similar phones.

Before the synthesis, however, the phones must have their duration and pitch modified in order to fulfil the prosodic constraints of the new words containing those phones. This processing is necessary to avoid the production of a monotonous sounding synthesized speech. In a TTS system, this function is performed by a prosodic module. To allow the duration and pitch modifications in the recorded subunits, many concatenation based TTS systems employ the time-domain pitch-synchronous overlap-add (TD-PSOLA) (E. Moulines and F. Charpentier, “Pitch synchronous waveform processing techniques for text-to-speech synthesis using diphones,” Speech Commun., vol. 9, pp. 453-467, 1990) model of synthesis.

When a signal is to be synthesized with an increased duration by means of a known PSOLA method, each of the pitch bells is repeated a number of times corresponding to the desired increase of the duration. For example, if the duration is to be doubled each period of the original signal is repeated. When this approach is applied to creaky voice, the resulting synthesized signal sounds unnatural and the creaky character of the voice is lost.

The present invention therefore aims to provide an improved method of synthesizing a signal which enables to synthesize creaky voice. Further the present invention aims to provide a corresponding computer program product and computer system, in particular, a text-to-speech system.

The present invention provides for a method of synthesizing a signal having alternating strong and weak periods as it is the case for creaky voice.

Creaky voice is often found at the end of a sentence where the pitch of a speaker is at its low end. Creaky voice is characterized by irregularity of pitch-period durations. One common version of creaky voice has alternating strong and weak periods. The present invention is based on the discovery that by application of a prior art PSOLA-type method for synthesizing a signal having an increased duration the alternation of the strong and weak periods is lost and that therefore an unnatural sounding amplitude variation is added to the synthesized speech. The invention enables to preserve such a creaky voice characteristic in the synthesized signal.

In accordance with a preferred embodiment of the invention the strong and the weak periods of an original creaky voice sound signal are classified by marking the periods with different class-types. This information is used to make an alternating choice between the strong and the weak periods. By choosing nearest neighboring periods for the selection of pitch bells also the form of the signal envelope is preserved in the synthesized signal having the increased duration.

The present invention is particularly advantageous for text-to-speech synthesis systems. In accordance with a preferred embodiment of the invention such a text-to-speech synthesis system contains a data file for storing classification information of the original sound signal. By means of this classification information creaky voice intervals having alternating strong and weak periods are identified.

This classification information can be generated by means of a computer program, which analyses the original signal in order to detect the characteristics of creaky voice within the signal. Alternatively this classification can be performed by a human expert. It is to be noted that the classification is only to be performed once; after the initial classification an unlimited number of signals of a variety of durations can be synthesized without further interaction.

In the following preferred embodiments of the invention are described in greater detail by making reference to the drawings in which:

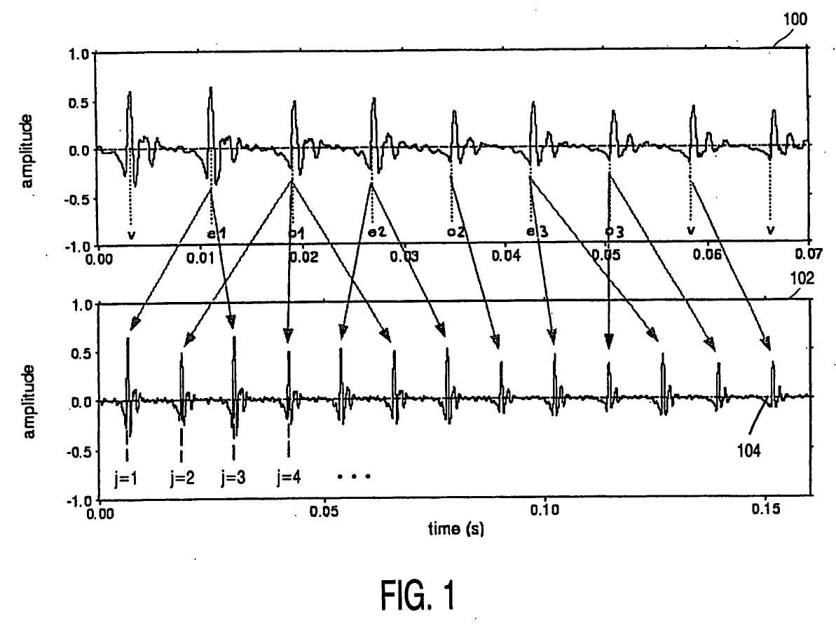

FIG. 1 is illustrative of a sound signal containing creaky voice and a synthesized signal having an increased duration,

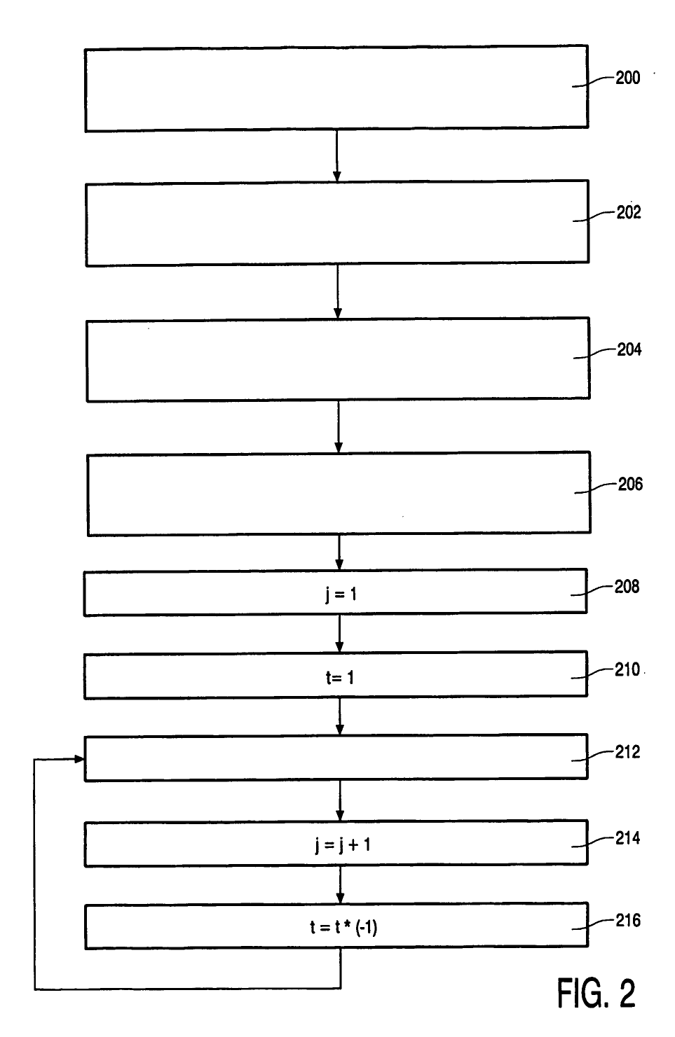

FIG. 2 is a flow chart of an embodiment of a method of the invention, and

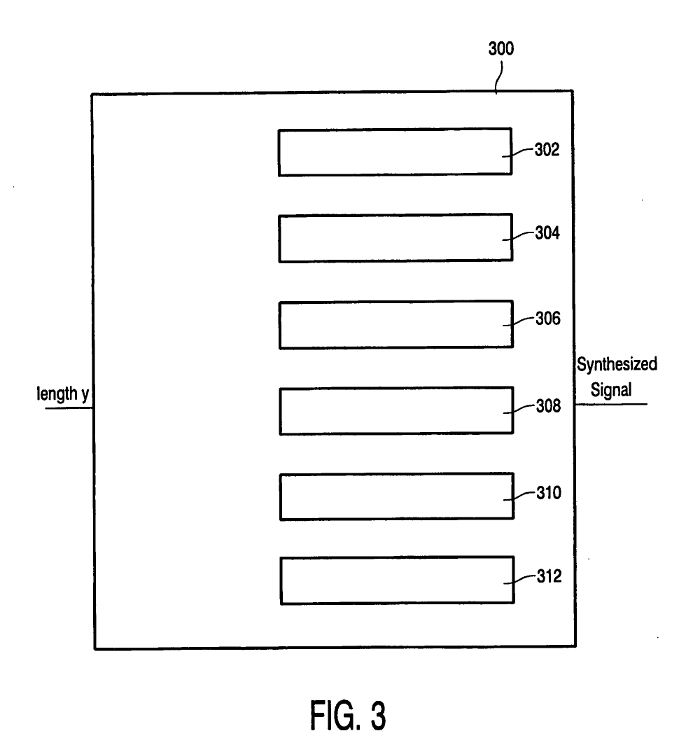

FIG. 3 is a block diagram of a preferred embodiment of a computer system.

FIG. 1 shows an original signal 100 having a duration of 0.07 seconds. The periods of the original signal 100 are classified as ‘v’, ‘e’ or ‘o’: The classifier ‘v’ identifies periods of type ‘voiced’; the classifiers ‘e’ and ‘o’ identify periods which are of type ‘creaky’, whereby ‘e’ designates strong periods and ‘o’ designates weak periods. In this context ‘weak’ means that the amplitude within that period of the creaky voice interval is lower than the amplitude of the immediately preceding period; likewise ‘strong’ means that the amplitude of that period of the creaky voice sound is higher than the amplitude of the immediately preceding period of the creaky voice sound interval. This classification of the original signal 100 can be performed by means of a computer program which analyses the original signal 100 in order to identify the above described signal characteristics. Alternatively this classification can also be performed manually by a human expert. It is preferred that the classification is performed in a first step by means of a computer program and is then reviewed in a second step by a human expert for improved precision of the classification. Original signal 100 and its classification serves as a basis to generate synthesized signal 102. The synthesized signal 102 is required to have a duration of about 0.16 seconds which is about twice the duration of the original signal 100. In order to synthesize the signal 102 with this required duration pitch bell locations j are determined on the time axis 104 in the domain of the synthesized signal 102. The pitch bell locations j are distanced on the time axis 104 by the period p as given by the fundamental frequency of the signal to be synthesized. It is to be noted that the signal to be synthesized can have the same or another pitch/fundamental frequency as the original signal. The first required pitch bell location j=1 is of type ‘e’ as it is the case for the first period e1 of the creaky voice sound interval within the original signal 100. As a consequence a pitch bell is obtained from the period e1 of the original signal 100 by means of windowing. The following required pitch bell location j=2 requires a pitch bell of type ‘o’ as the synthesis of creaky voice requires alternating strong and weak periods. In order to also maintain the form of the signal envelope within the creaky voice sound period within original signal 100 a pitch bell is obtained from the nearest neighboring period of type ‘o’ within the original signal 100, which is period o1. The following required pitch bell location j=3 again requires a pitch bell of type ‘e’. This pitch bell is obtained from a period that is categorized as ‘e’ within the original signal 100 which is the nearest neighbor to the required pitch bell location j=3. This nearest neighbor is the period e1 within original signal 100. This means that a pitch bell is obtained for pitch bell location j=3 by windowing period e1 of the original signal 100.

Likewise the consecutive pitch bell location j=4 needs to be of type ‘o’. Again the closest period of that type within original signal 100 is selected in order to obtain a pitch bell. This closest period of the required type is the period o1. This process is performed with respect to all required pitch bell locations j on time axis 100 in order to obtain a pitch bell for each of the required pitch bell locations.

The resulting pitch bells are then overlapped and added in order to synthesize the required signal 102 containing synthesized creaky voice with an increased duration. The resulting synthesized signal 102 has a sequence of alternating strong and weak periods as it is the case in the original signal 100 in order to maintain this aspect of the original signal characteristic. Because of the fact that always nearest neighboring periods of the required category are selected from the original signal 100 for obtaining the pitch bells also the form of the signal envelope of the creaky part of the original signal 100 is preserved. The result is a natural sounding synthesized signal 102 having all of the characteristics of the original creaky voice sound signal but with an increased duration.

FIG. 2 shows a corresponding flow chart. In step 200 an original sound signal is provided. The original sound signal contains at least one interval containing creaky voice. In step 202 creaky voice sound periods are identified and classified. This can be done manually, by means of a computer program or with the assistance of a computer program. To retain the naturalness of the creak, the strong and weak periods are marked with different class-types and this information is used to make an alternating choice between the strong and weak periods. Strong (even) periods are marked by type ‘1’ and weak (odd) periods are marked by type ‘−1’. In step 204 pitch bells are obtained from the original sound signal by means of windowing. The windowing operation is performed by means of windows which are positioned synchronously with the fundamental frequency of the original sound. In step 206 the required pitch bell locations j in the time domain of the signal to be synthesized are determined. If the signal to be synthesized is required to have a certain duration this implies that a number of x pitch bell locations which are spaced apart by the period p are required where the number x is greater than the number of periods contained in the original signal. In step 208 the index j is initialized to be equal to 1. In step 210 the index t is initialized to be equal to 1. The index t indicates the type which is either ‘1’ or ‘−1’. In step 212 a pitch bell is selected for the pitch bell location j in the time domain of the signal to be synthesized. This selection is performed by searching for the nearest neighbor of pitch bell location j in the time domain of the original signal which has the required type t. This way a pitch bell of type t is selected from the nearest neighbor of pitch bell location j in the time domain of the original signal. In step 214 the index j is incremented in order to go to the next pitch bell location j. In step 216 the type parameter t is multiplied by −1 in order to change the required type to the category ‘weak’. As a consequence in the following step 212 a nearest neighbor for the consecutive pitch bell location j which is of type ‘−1’ is selected from the domain of the original signal. Steps 212, 214 and 216 are repeatedly carried out until pitch bells have been selected for all of the required pitch bell locations j. After this selection process has been completed an overlap and add operation is performed; the resulting signal contains creaky voice and has the required duration.

FIG. 3 shows a block diagram of a computer system 300, such as a text-to-speech system. The computer system 300 has a module 302 for storing of a recording of an original sound signal comprising a creaky voice sound interval. Module 304 serves to store sound classification information, i.e. storing of classifiers ‘v’, ‘e’ and ‘o’ as it is illustrated in the example of FIG. 1. Module 306 serves for windowing of the original sound signal in order to obtain pitch bells. Module 308 serves to determine the required pitch bell locations in the domain of the signal to be synthesized. This is done based on the required length y of the signal to be synthesized, the required fundamental frequency of the signal to be synthesized, which may or may not be equal to fundamental frequency of the original sound signal. Module 310 serves for selection of pitch bells which are obtained from module 306. The pitch bells are selected in accordance with steps 212, 214 and 216 as illustrated in FIG. 2. This means that creaky voice is obtained by creating a sequence of alternating strong and weak periods while preserving the form of the signal envelope of the original sound. Module 312 serves to perform an overlap and add operation on the pitch bells selected by module 310. This way the required synthesized signal is obtained.

1. A method of synthesizing a signal comprising the steps of:
a) providing of a first signal having first periods of a first type and second periods of a second type in an alternating sequence,
b) windowing of the first signal to provide a pitch bell for each of the fist and second periods,
c) determining a number of required pitch bell locations for a second signal to be synthesized,
d) selecting of one of the pitch bells for a first one of the required pitch bell locations by identifying the nearest neighboring period of the first one of the required pitch bell locations being of the first type, and selecting of the pitch bell of the identified period,
e) selecting of one of the pitch bells for a second one of the required pitch bell locations by identifying a nearest neighboring period of the second one of the required pitch bell locations having the second type, and selecting the pitch bell of the identified period,
whereby the steps d) and e) are carried out for all of the required pitch bell locations,
f) performing an overlap and add operation on the selected pitch bells in order to synthesize the second signal.

2. The method of claim 1, the first signal having alternating strong and weak periods of substantially the same signal form.

3. The method of claims 1 or 2, the first signal being a creaky voice signal.

4. The method of claims 1, 2 or 3, whereby the required pitch bell locations are determined in order to increase the duration of the second signal to be synthesized.

5. A computer program product, in particular digital storage medium, comprising program means for performing the steps of:
a) providing of a first signal having first periods of a first type and second periods of a second type in an alternating sequence,
b) windowing of the first signal to provide a pitch bell for each of the fist and second periods,
c) determining a number of required pitch bell locations for a second signal to be synthesized,
d) selecting of one of the pitch bells for a first one of the required pitch bell locations by identifying the nearest neighboring period of the first one of the required pitch bell locations being of the first type, and selecting of the pitch bell of the identified period,
e) selecting of one of the pitch bells for a second one of the required pitch bell locations by identifying a nearest neighboring period of the second one of the required pitch bell locations having the second type, and selecting the pitch bell of the identified period,
whereby the steps d) and e) are carried out for all of the required pitch bell locations,
f) performing an overlap and add operation on the selected pitch bells in order to synthesize the second signal.

6. The computer program product of claim 5 the program means being adapted to determine the required pitch bell locations in accordance with a required duration of the second signal to be synthesized.

7. A computer system, in particular text-to-speech synthesis system, comprising:
means for providing of a first signal having first periods of a first type and second periods of a second type in an alternating sequence,
means for windowing of the first signal to provide a pitch bell for each of the fist and second periods,
means for determining a number of required pitch bell locations for a second signal to be synthesized,
means for selecting of one of the pitch bells for a first one of the required pitch bell locations by identifying the nearest neighboring period of the first one of the required pitch bell locations being of the first type, and selecting of the pitch bell of the identified period, and for selecting of one of the pitch bells for a second one of the required pitch bell locations by identifying a nearest neighboring period of the second one of the required pitch bell locations having the second type, and selecting the pitch bell of the identified period,
means for performing an overlap and add operation on the selected pitch bells in order to synthesize the second signal

8. The computer system of claim 7 further comprising means for storing of classification data for identifying first and second periods of the first signal.

9. A synthesized signal comprising a number of pitch bells which are overlapped and added, the pitch bells being of first and second types, the first and second types having substantially the same signal form and varying amplitudes, the pitch bells being selected to form an alternating sequence of first and second type pitch bells.
